(19) United States
(12) Patent Application Publication
(10) Pub. No.: US 2011/0141509 A1
(43) Pub. Date: Jun. 16, 2011

(54) IMAGE FORMING APPARATUS AND IMAGE FORMING METHOD

(75) Inventor: Atsushi Kato, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/964,927

(22) Filed: Dec. 10, 2010

Related U.S. Application Data
(60) Provisional application No. 61/285,430, filed on Dec. 10, 2009.

(51) Int. Cl. G06F 3/12

(52) U.S. Cl. 358/1.13

(57) ABSTRACT

According to one embodiment, an image forming apparatus includes a facsimile-printing-role-information acquiring unit configured to acquire, in user unit, facsimile printing role information indicating whether facsimile data is handled, a forced-printing-information acquiring unit configured to acquire forced printing information indicating whether received facsimile data is forcibly printed, a facsimile-data-reception processing unit configured to, when facsimile data is received, print the facsimile data if the forced printing information indicates that forced printing is possible and store the facsimile data when the forced printing information indicates that the forced printing is impossible, an authenticating unit configured to authenticate a user who logs in to the image forming apparatus, and a facsimile-data-output processing unit configured to, when the user is authenticated, control display and printing of a received facsimile job on the basis of the facsimile printing role information and the forced printing information.

### CROSS-REFERENCE TO RELATED APPLICATION

This application is based upon and claims the benefit of U.S. Provisional Application No. 61/285,430, filed on Dec. 10, 2009; the entire contents of which are incorporated herein by reference.

### FIELD

Embodiments described herein relate generally to an image forming apparatus and an image forming method.

### BACKGROUND

As a form of an image forming apparatus, there is an apparatus called MFP (Multi-Function Peripheral). The MFP is a digital complex machine that realizes plural functions such as a scanner function, a facsimile function, and an image data storing function in addition to a copying function and that alone plays roles of plural apparatuses.

An MFP in the past immediately performs printing after facsimile reception or once stores a facsimile-received document in a memory or the like. All users who operate the MFP can print all received facsimiles by performing predetermined printing operation. However, amid the increasing importance of security in recent years, it is considered problematic in terms of security that anybody can view facsimiles transmitted to others.

### DESCRIPTION OF THE DRAWINGS

FIG. 1 is an exemplary diagram of a network configuration including an image forming apparatus according to an embodiment;

FIG. 2 is an exemplary diagram of the configuration of the image forming apparatus according to an embodiment;

FIG. 3 is an exemplary diagram of the structure of an authentication database according to an embodiment;

FIG. 4 is an exemplary diagram of the structure of a role management database according to an embodiment;

FIG. 5 is an exemplary flowchart for explaining an operation procedure of the image forming apparatus during facsimile reception according to an embodiment;

FIG. 6 is an exemplary flowchart for explaining a printing control operation for a facsimile-received document in the image forming apparatus according to an embodiment;

FIG. 7 is an exemplary diagram of an authentication screen according to an embodiment;

FIG. 8 is an exemplary diagram of a facsimile-received job display screen according to an embodiment;

FIG. 9 is an exemplary diagram of the structure of a role management database according to an embodiment;

FIG. 10 is an exemplary flowchart for explaining an operation procedure during facsimile reception according to an embodiment;

FIG. 11 is an exemplary flowchart for explaining a printing control operation for a facsimile-received document in the image forming apparatus according to an embodiment; and

FIG. 12 is an exemplary diagram of a facsimile-received job display screen according to an embodiment.

### DETAILED DESCRIPTION

In general, according to one embodiment, an image forming apparatus includes: a facsimile-printing-role-information acquiring unit configured to acquire, in user unit, facsimile printing role information indicating whether facsimile data is handled; a forced-printing-information acquiring unit configured to acquire forced printing information indicating whether received facsimile data is forcibly printed; a facsimile-data-reception processing unit configured to, when facsimile data is received, print the facsimile data if the forced printing information indicates that forced printing is possible and store the facsimile data when the forced printing information indicates that the forced printing is impossible; an authenticating unit configured to authenticate a user who logs in to the image forming apparatus; and a facsimile-data-output processing unit configured to, when the user is authenticated, control display and printing of a received facsimile job on the basis of the facsimile printing role information and the forced printing information.

Exemplary embodiments of the image forming apparatus and image forming method according to the present invention are explained below with reference to the accompanying drawings.

### First Embodiment

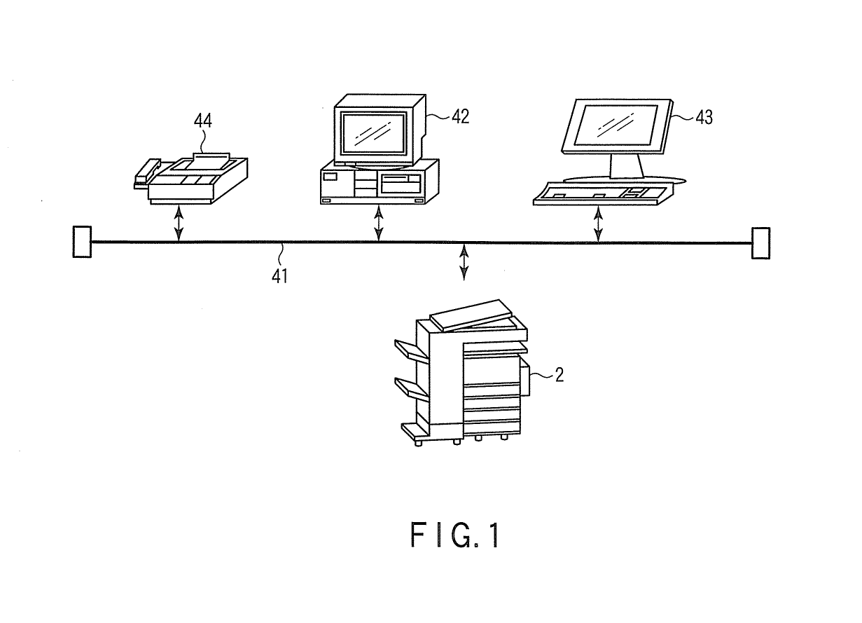

FIG. 1 is an exemplary diagram of a network configuration including an image forming apparatus according to an embodiment.

An MFP 2 is connected to PCs (personal computers) 42 and 43 and a facsimile apparatus 44 via a network 41. The MFP 2 not only operates according to operation from a control panel provided in the MFP 2 but also operates according to an input from a PC or the like connected to the network 41. For example, a general user operates the MFP 2 using the PC 42. An administrator operates the MFP 2 using the PC 43. The MFP 2 acquires, via the network 41, information received by the facsimile apparatus 44.

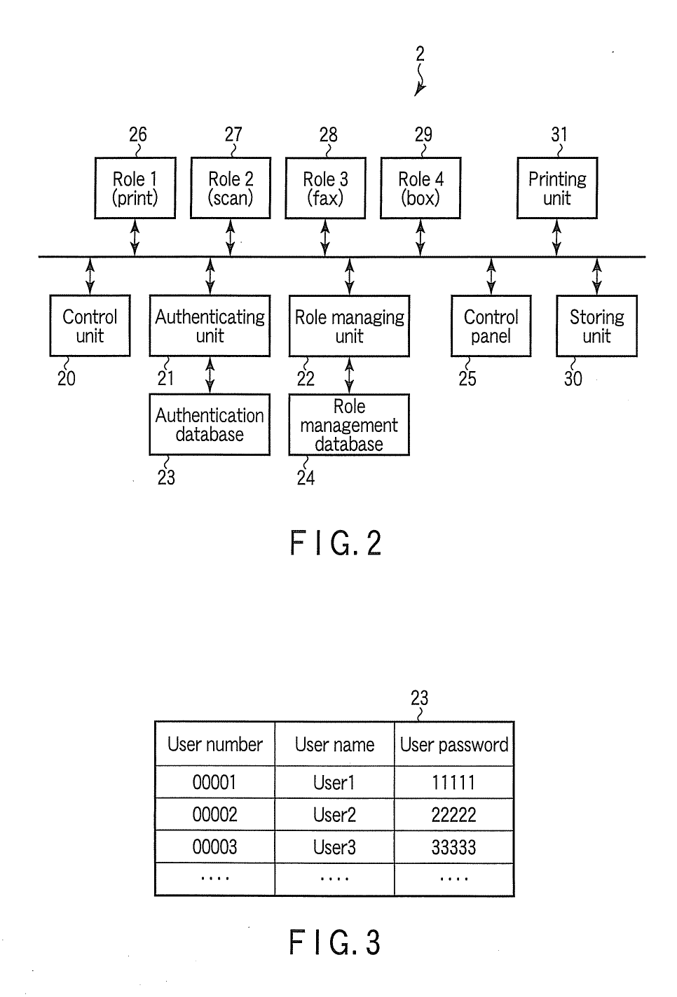

FIG. 2 is an exemplary diagram of the configuration of an image forming apparatus according to an embodiment.

The MFP 2 is an apparatus that alone can play roles of plural apparatuses such as a copying machine, a scanner, a facsimile apparatus, and an image data recording apparatus (a BOX apparatus).

For, example, it is assumed that the MFP 2 has a role of the copying machine (a), a role of the scanner (b), a role of the facsimile apparatus (c), and a role of the image data storing apparatus (d). The MFP 2 permits a user A to use the roles (a) and (c) and prohibits the user A from using the roles (b) and (d). On the other hand, the MFP 2 permits another user B to use the roles (a), (b), and (d) and prohibits the user B from using the role (c). Such a management function is called role management function.

In FIG. 2, as an example of the roles of these plural apparatuses, the role of the copying machine is indicated by a role (1) 26, the role of the scanner is indicated by a role (2) 27, the role of the facsimile apparatus for handling facsimile data is indicated by a role (3) 28, and the role of the BOX apparatus is indicated by a role (4) 29. The role of the facsimile apparatus is hereinafter referred to as “facsimile printing role”.

The MFP 2 includes a control unit 20, an authenticating unit 21, a role managing unit 22, an authentication database 23, a role management database 24, a control panel 25, a log recording unit 30, and a printing unit 31.

The control unit 20 collectively controls the MFP 2. The control panel 25 receives instructions for setting and execution of various functions input by a user and displays and notifies the user of necessary information. The authenticating unit 21 performs user authentication by determining whether authentication information input from the control panel 25 or the PC 42 and authentication information registered in the authentication database 23 coincide with each other.

The role managing unit 22 executes role management on the basis of data registered in the role management database 24. Roles allocated to each user are registered in advance in the role management database 24. The role managing unit 22 permits the user to use only the roles allocated to the user.

The control unit 20 handles facsimile data received by the control unit 20 or facsimile data transmitted from the facsimile apparatus 44. The control unit 20 stores the facsimile data in the storing unit 30, prints the facsimile data with the printing unit 31, and displays the facsimile data on the control panel 25 or the PCs 42 and 43.

FIG. 3 is an exemplary diagram of the structure of the authentication database according to an embodiment. The authentication database 23 is a database used for user authentication. In the authentication database 23, association between information concerning users represented by “user number”, “user name”, and the like and “user password” as authentication information is registered.

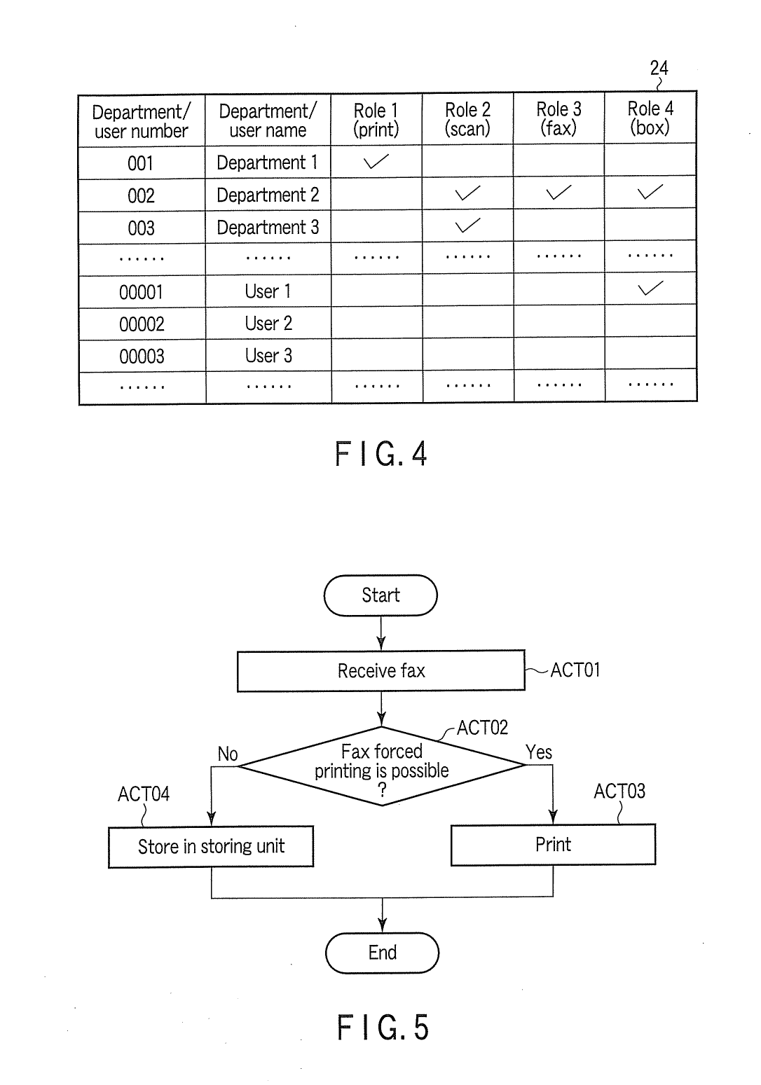

FIG. 4 is an exemplary diagram of the structure of the role management database according to an embodiment. The role management database 24 is a database used for user role management. In the role management database 24, a data region indicating allocation of roles in department unit and a data region indicating allocation of roles in user unit are provided. In a table shown in FIG. 4, check marks indicate that roles are allocated and blanks indicate that roles are not allocated.

In the data region in department unit, association between departments represented by “department number”, “department name”, and the like and roles allocated to the departments is registered. In an example shown in FIG. 4, a role (1) is allocated to “Department 1”, roles (2), (3), and (4) are allocated to “Department 2”, and the role (2) is allocated to “Department 3”.

In the data region in user unit, association between users represented by “user number”, “user name”, and the like and roles allocated to the users is registered. In the example shown in FIG. 4, only the role (4) is allocated to “User 1” and the roles (1), (2), and (3) are not allocated to “User 1”. Only the role (3) is allocated to “User 2”. No role is allocated to “User 3”.

The database 23 for user authentication and the database 24 for role management do not always need to be provided independently from each other and may be formed as an integral database obtained by combining both the databases. A database is not limited to the form shown in FIG. 4. In a role management database 24, a database indicating allocation of roles in department unit and a database indicating allocation of roles in user unit may be provided independently from each other.

An administrator can perform setting of possibility of facsimile document forced printing. The setting of possibility of facsimile document forced printing is setting concerning whether it is possible to immediately forcibly print received facsimile data in MFP 2 unit. In other words, if the forced printing is set as possible, the received facsimile document is immediately printed. If the forced printing is set as impossible, the facsimile data is once stored in the storing unit 30. The facsimile data is printed after a printing instruction is received. The setting of possibility of facsimile document forced printing can also be performed from the control panel 25 and can also be performed from the PC 43. Set possibility information is stored in the storing unit 30.

FIG. 5 is an exemplary flowchart for explaining an operation procedure of the image forming apparatus during facsimile reception according to an embodiment.

In Act 01, the control unit 20 receives facsimile data. In Act 02, the control unit 20 checks the possibility information stored in the storing unit 30. If the facsimile document forced printing is set as possible (Yes in Act 02), in Act 03, the printing unit 31 prints the facsimile data. If the facsimile document forced printing is set as impossible (No in Act 02), in Act 04, the control unit 20 stores the facsimile data in the storing unit 30.

A printing control operation for a facsimile-received document in the image forming apparatus according to this embodiment is explained below.

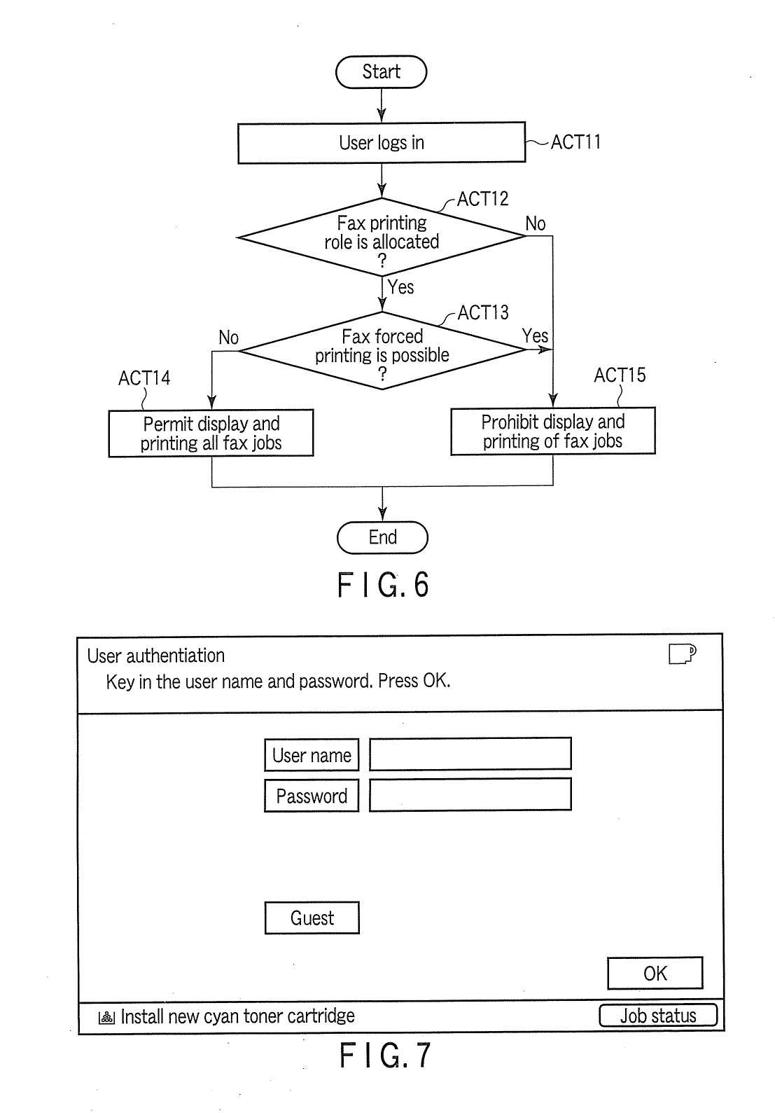

FIG. 6 is an exemplary flowchart for explaining the printing control operation for facsimile-received document in the image forming apparatus according to an embodiment. An operation performed when a user operates the image forming apparatus from the PC 42 is explained below.

In Act 11, the user inputs authentication information from an authentication screen and executes login operation. FIG. 7 is an exemplary diagram of the authentication screen according to an embodiment. When the user inputs a user name and a password and depresses an OK button, the MFP 2 authenticates the user on the basis of the input user name and password.

The authenticating unit 21 refers to the authentication database 23 and, if the input user name and password are registered, determines that user authentication is valid. If the input user name and password are not registered, the authenticating unit 21 determines that the user authentication is invalid.

In Act 12, the control unit 20 refers to the authentication database 23 and checks whether the facsimile printing role is allocated to the login user. If the facsimile printing role is allocated to the login user (Yes in Act 12), in Act 13, the control unit 20 checks the possibility information stored in the storing unit 30. If the facsimile document forced printing is set as impossible (No in Act 13), in Act 14, the control unit 20 permits display and printing of all facsimile-received jobs by the login user.

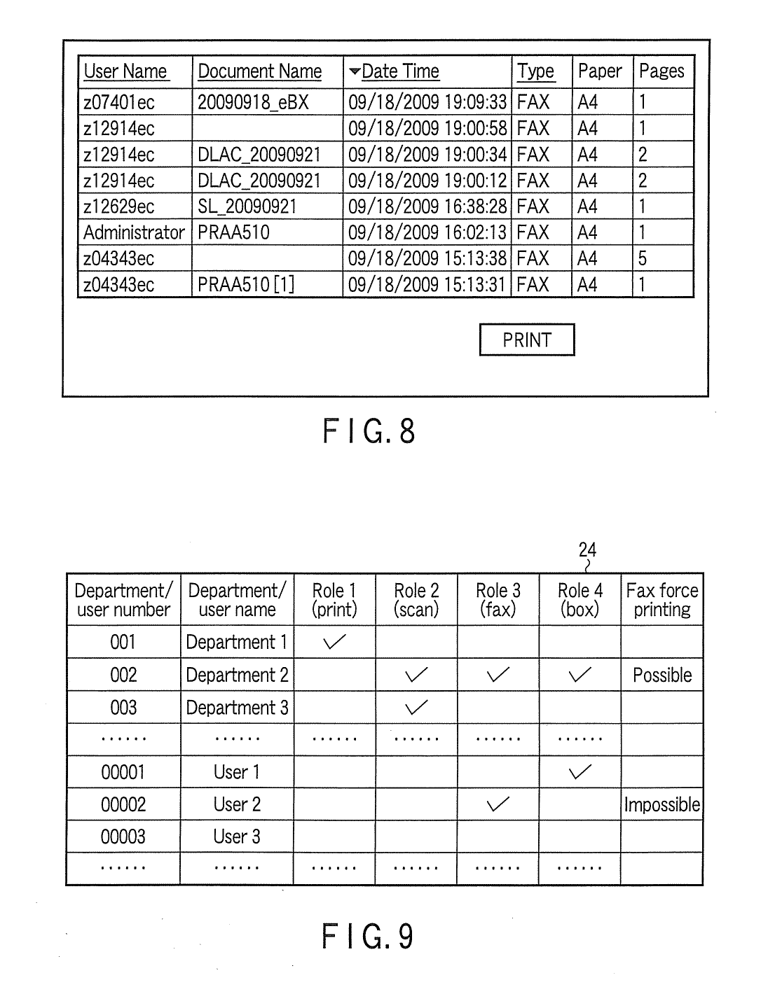

FIG. 8 is an exemplary diagram of a facsimile-received job display screen according to an embodiment. In the facsimile-received job display screen shown in FIG. 8, user names, document names, facsimile reception date and times, types of jobs, sheet sizes, and the numbers of sheets are displayed concerning facsimile-received jobs. When the user checks display contents and operates a print button, the printing unit 31 prints all the facsimile-received jobs.

The facsimile printing role is allocated to the login user. Therefore, the user is regarded as being specially given an authority for printing facsimile data and is permitted to display and print the facsimile-received jobs.

On the other hand, if the facsimile printing role is not allocated to the login user (No in Act 12) and if the facsimile document forced printing is set as possible (Yes in Act 13), in Act 15, the control unit 20 prohibits display and printing of all the facsimile-received jobs by the login user.

The facsimile printing role is not allocated to the login user. Therefore, the user is regarded as not being given the authority for printing facsimile data. If the facsimile document forced printing is set as possible, since printing is already performed, it is unnecessary to perform printing again.

### Variation of the First Embodiment

In a variation of the first embodiment, a function of controlling facsimile printing on the basis of information for specifying a transmission source (e.g., a telephone number) is provided.

For example, in FIG. 5, when the facsimile is received in Act 01, if a transmission source is a specific transmission source set in advance, the control unit 20 executes the processing in Act 04 and stores the facsimile data in the storing unit 30. If the transmission source is not the specific transmission source set in advance, the control unit 20 executes the processing in Act 02.

According to a mode of this variation, since printing of the facsimile from the specific transmission source can be limited, security can be further improved.

In the first embodiment and the mode of the variation of the first embodiment, the printing of the facsimile-received jobs is executed when the login user performs the printing operation. However, when a user to whom the facsimile printing role is allocated logs in, printing of all the facsimile-received jobs may be automatically executed.

### Second Embodiment

A second embodiment is different from the first embodiment only in that the setting of possibility of facsimile document forced printing is performed for each user. Therefore, components same as those in the first embodiment are denoted by the same reference numerals and signs and detailed explanation of the components is omitted.

FIG. 9 is an exemplary diagram of the structure of a role management database according to an embodiment. In the role management database 24 according to the second embodiment, “facsimile forced printing” spaces are respectively provided in a data region indicating allocation of roles in department unit and a data region indicating allocation of roles in user unit. Specifically, when a facsimile printing role is allocated, an administrator can perform the setting of possibility of facsimile document forced printing in department unit and user unit. Set possibility information is stored in the “facsimile forced printing” spaces of the role management database 24.

In an example shown in FIG. 9, a facsimile printing role of a role (3) is allocated to “Department 2” and the facsimile document forced printing is set as possible. The facsimile printing role of the role (3) is allocated to “User 2” and the facsimile document forced printing is set as impossible.

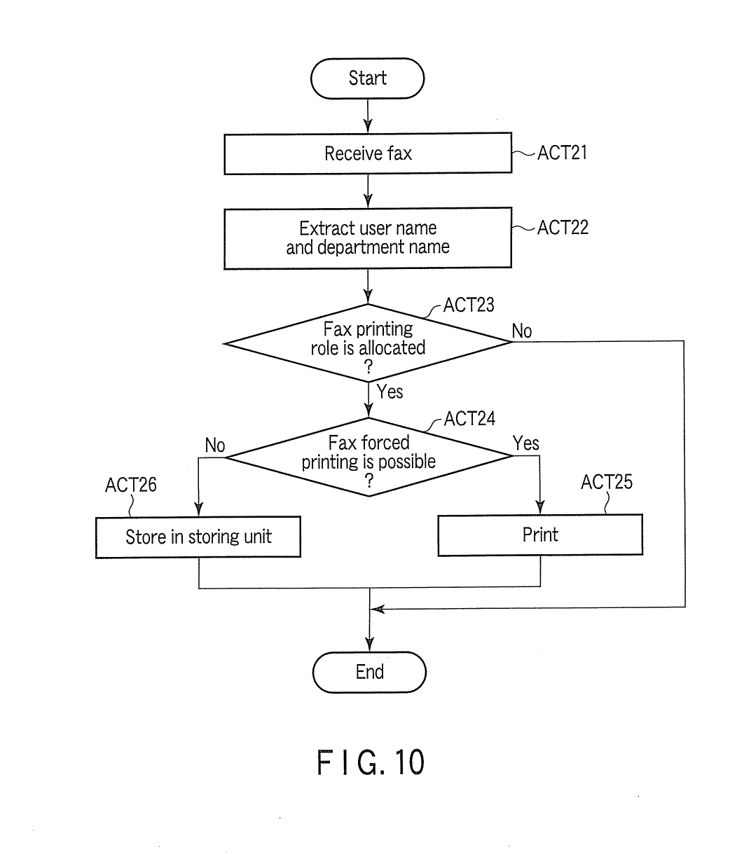

FIG. 10 is an exemplary flowchart for explaining an operation procedure during facsimile reception according to an embodiment.

In Act 21, the control unit 20 receives facsimile data. In Act 22, the control unit 20 extracts a user name or a department name as a destination from the facsimile data. A destination of a facsimile is often described in a predetermined position of facsimile data. Therefore, the destination is extracted by applying an image processing technique and a character recognition technique to portions where the destination is likely to be described.

In Act 23, the control unit 20 checks whether the facsimile printing role is allocated to a relevant destination in the role management database 24. If the facsimile printing role is not allocated, the control unit 20 ends this processing. If the facsimile printing role is allocated, the control unit 20 executes the next processing.

In Act 24, the control unit 20 checks the possibility information in the “facsimile forced printing” space corresponding to the relevant destination in the role management database 24. If the facsimile document forced printing is set as possible (Yes in Act 24), in Act 25, the printing unit 31 prints the facsimile data. If the facsimile document forced printing is set as impossible (No in Act 24), in Act 26, the control unit 20 stores the facsimile data in the storing unit 30. If the facsimile printing role is not allocated to the relevant destination in the role management database 24, the control unit 20 ends the processing without performing any operation.

A printing control operation for a facsimile-received document in the image forming apparatus according to this embodiment is explained below.

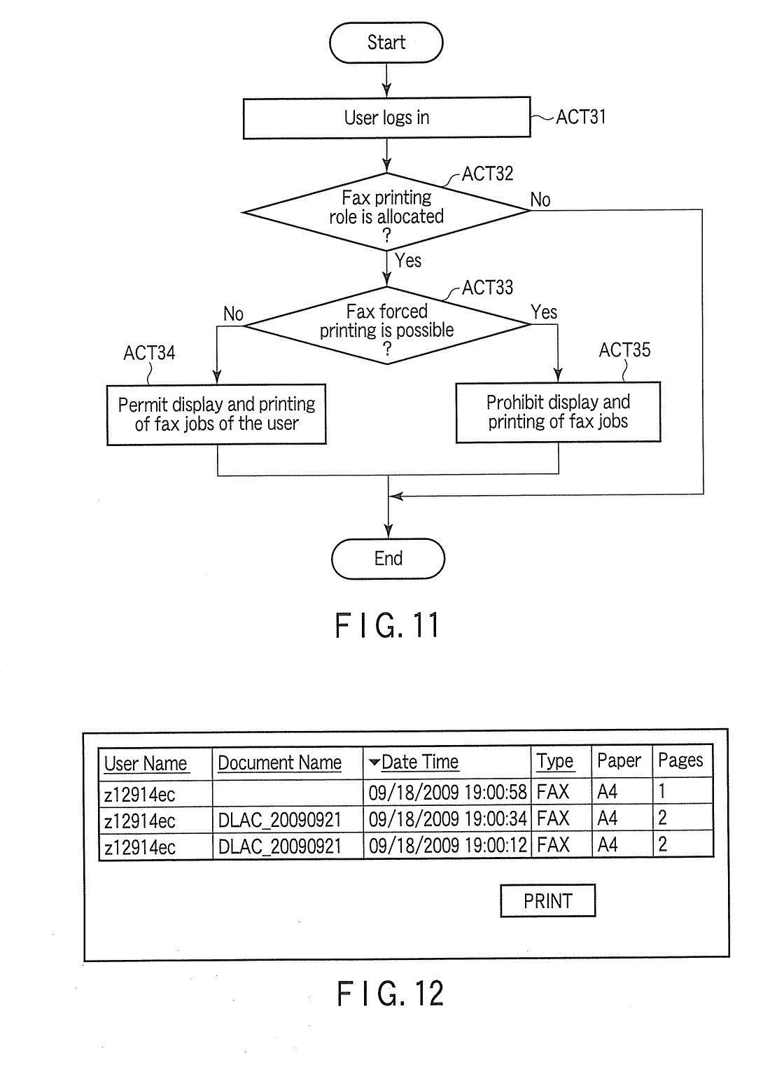

FIG. 11 is an exemplary flowchart for explaining a printing control operation for a facsimile-received document in the image forming apparatus according to an embodiment. An operation performed when a user operates the image forming apparatus from the PC 42 is explained below.

In Act 31, the user inputs authentication information from an authentication screen and executes login operation. Since an authentication method is the same as the content explained with reference to FIG. 7, repeated, explanation of the authentication method is omitted.

In Act 32, the control unit 20 refers to the authentication database 23 and the role management database 24 and checks whether the facsimile printing role is allocated to the login user. If the facsimile printing role is allocated (Yes in Act 32), in Act 33, the control unit 20 checks the possibility information stored in the role management database 24. If the facsimile document forced printing is set as impossible (No in Act 33), in Act 34, the control unit 20 permits display and printing of facsimile-received jobs concerning the login user.

FIG. 12 is an exemplary diagram of a facsimile-received job display screen according to an embodiment. In the facsimile-received job display screen shown in FIG. 12, user names, document names, facsimile reception date and times, types of jobs, sheet sizes, and the numbers of sheets are displayed concerning facsimile-received jobs. When the user checks display contents and operates a print button, the printing unit 31 prints the facsimile-received jobs of the login user.

On the other hand, if the facsimile printing role is not allocated to the login user (No in Act 32) and when the facsimile document forced printing is set as possible (Yes in Act 33), in Act 35, the control unit 20 prohibits display and printing of the facsimile-received jobs concerning the login user.

In the embodiments explained above, the printing of the facsimile-received jobs is executed when the login user performs the printing operation. However, when a user to whom the facsimile printing role is allocated logs in, printing of facsimile-received jobs concerning the user may be executed even if the user does not perform the printing operation.

The functions explained in the embodiments may be configured by using hardware. The functions may be realized by causing a computer to read a computer program describing the functions using software. The functions may be configured by selecting the software or the hardware as appropriate.

It is also possible to realize the functions by causing the computer to read the computer program stored in a not-shown recording medium. A recording form of the recording medium in this embodiment may be any form as long as the recording medium can record the computer program and is computer-readable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a facsimile-printing-role-information acquiring unit configured to acquire, in user unit, facsimile printing role information indicating whether facsimile data is handled;
a forced-printing-information acquiring unit configured to acquire forced printing information indicating whether received facsimile data is forcibly printed;
a facsimile-data-reception processing unit configured to, when facsimile data is received, print the facsimile data if the forced printing information indicates that forced printing is possible and store the facsimile data if the forced printing information indicates that the forced printing is impossible;
an authenticating unit configured to authenticate a user who logs in to the image forming apparatus; and
a facsimile-data-output processing unit configured to, when the user is authenticated, control display and printing of a received facsimile job on the basis of the facsimile printing role information and the forced printing information.

2. The apparatus according to claim 1, wherein the forced-printing-information acquiring unit acquires the forced printing information in image forming apparatus unit.

3. The apparatus according to claim 2, wherein the facsimile-data-output processing unit displays or prints, if the facsimile printing role information concerning the authenticated user indicates that facsimile data is handled and if the forced printing information indicates that the forced printing is impossible, stored all facsimile data according to operation of the user.

4. The apparatus according to claim 2, wherein the facsimile-data-output processing unit prohibits, if the facsimile printing role information concerning the authenticated user indicates that facsimile data is not handled or if the forced printing information indicates that the force printing is possible, display and printing of stored all facsimile data by operation of the user.

5. The apparatus according to claim 2, further comprising a transmission-source-information acquiring unit configured to acquire information concerning a transmission source of received facsimile data, wherein
the facsimile-data-reception processing unit stores the facsimile data if the acquired transmission source is a predetermined transmission source.

6. The apparatus according to claim 5, wherein the facsimile-data-output processing unit displays or prints, if the facsimile printing role information concerning the authenticated user indicates that facsimile data is handled and if the forced printing information indicates that the forced printing is impossible, stored all facsimile data according to operation of the user.

7. The apparatus according to claim 5, wherein the facsimile-data-output processing unit prohibits, if the facsimile printing role information concerning the authenticated user indicates that facsimile data is not handled or if the forced printing information indicates that the force printing is possible, display and printing of stored all facsimile data by operation of the user.

8. The apparatus according to claim 1, further comprising a destination-information acquiring unit configured to acquire information concerning a user as a destination from received facsimile data, wherein
the forced-printing-information acquiring unit acquires the forced printing information in user unit.

9. The apparatus according to claim 8, wherein the facsimile-data-output processing unit displays or prints, if the facsimile printing role information concerning the authenticated user indicates that facsimile data is handled and if the forced printing information indicates that the forced printing is impossible, stored all facsimile data according to operation of the user.

10. The apparatus according to claim 8, wherein the facsimile-data-output processing unit prohibits, if the facsimile printing role information concerning the authenticated user indicates that facsimile data is not handled or if the forced printing information indicates that the force printing is possible, display and printing of stored all facsimile data by operation of the user.

11. An image forming method of an image forming apparatus comprising:
acquiring, in user unit, facsimile printing role information indicating whether facsimile data is handled;
acquiring forced printing information indicating whether received facsimile data is forcibly printed;
when facsimile data is received, printing the facsimile data if the forced printing information indicates that forced printing is possible and storing the facsimile data if the forced printing information indicates that the forced printing is impossible;
authenticating a user who logs in to the image forming apparatus; and
when the user is authenticated, controlling display and printing of a received facsimile job on the basis of the facsimile printing role information and the forced printing information.

12. The method according to claim 11, wherein the forced printing information is acquired in image forming apparatus unit.

13. The method according to claim 12, wherein the controlling display and printing of the facsimile job includes displaying and printing, if the facsimile printing role information concerning the authenticated user indicates that facsimile data is handled and if the forced printing information indicates that the forced printing is impossible, stored all facsimile data according to operation of the user.

14. The method according to claim 12, wherein the controlling display and printing of the facsimile job includes prohibiting, if the facsimile printing role information concerning the authenticated user indicates that facsimile data is not handled or if the forced printing information indicates that the force printing is possible, display and printing of stored all facsimile data by operation of the user.

15. An image forming method of an image forming apparatus comprising:
acquiring, in user unit, facsimile printing role information indicating whether facsimile data is handled;
acquiring forced printing information indicating whether received facsimile data is forcibly printed;
when facsimile data is received, acquiring information concerning a transmission source of the received facsimile data;
storing the facsimile data if the acquired transmission source is a predetermined transmission source;
printing the facsimile data if the acquired transmission source is not the predetermined transmission source and if the forced printing information indicates that the forced printing is possible;
storing the facsimile data if the acquired transmission source is not the predetermined transmission source and if the forced printing information indicates that the forced printing is impossible;
authenticating a user who logs in to the image forming apparatus; and
when the user is authenticated, controlling display and printing of a received facsimile job on the basis of the facsimile printing role information and the forced printing information.

16. The method according to claim 15, wherein the forced printing information is acquired in image forming apparatus unit.

17. The method according to claim 16, wherein the controlling display and printing of the facsimile job includes displaying and printing, if the facsimile printing role information concerning the authenticated user indicates that facsimile data is handled and if the forced printing information indicates that the forced printing is impossible, stored all facsimile data according to operation of the user.

18. The method according to claim 16, wherein the controlling display and printing of the facsimile job includes prohibiting, if the facsimile printing role information concerning the authenticated user indicates that facsimile data is not handled or if the forced printing information indicates that the force printing is possible, display and printing of stored all facsimile data by operation of the user.
